(19) United States
(12) Patent Application Publication
(10) Pub. No.: US 2019/0095884 A1
(43) Pub. Date: Mar. 28, 2019

(54) ELECTRONIC SYSTEM AND METHOD FOR FACILITATING PAYMENT OF A TRANSACTION

(71) Applicant: Mastercard International Incorporated, Purchase, NY (US)

(72) Inventor: Manjul Chawda, Pune (IN)

(73) Assignee: Mastercard International Incorporated, Purchase, NY (US)

(21) Appl. No.: 16/108,209

(22) Filed: Aug. 22, 2018

(30) Foreign Application Priority Data
Sep. 22, 2017 (SG) 10201707844X

(51) Int. Cl. G06Q 20/10; G06Q 20/32; G06Q 30/02; G06Q 20/40

(52) U.S. Cl. CPC G06Q 20/10; G06Q 20/40145; G06Q 30/0222; G06Q 20/322

(57) ABSTRACT

The present disclosure generally relates to an electronic system, a computerized method, and a non-transitory computer-readable storage medium for facilitating payment of a transaction with a consumer. The system comprises a server configured for performing steps of the method, comprising: receiving a transaction initiation request from an electronic device of the consumer; communicating, to the consumer electronic device, identification details of a number of merchants retrieved from a merchant database; receiving, from the consumer electronic device, a selection of a merchant from the number of merchants, the transaction performed with the selected merchant; receiving, from the consumer electronic device, details of a payment instrument of the consumer and cost data of the transaction; retrieving, from the merchant database, details of a financial account of the selected merchant; and communicating the consumer payment instrument details, transaction cost data, and merchant financial account details to a payment network for processing payment of the transaction.

### CROSS REFERENCE TO RELATED APPLICATIONS

This application claims priority to Singaporean Application Serial No. 10201707844X, filed Sep. 22, 2017, which is incorporated herein by reference in its entirety

### TECHNICAL FIELD

The present disclosure generally relates to an electronic system and method for facilitating payment of a transaction. Particularly, the present disclosure describes various embodiments of an electronic system and method for facilitating payment of a transaction with a consumer, and more particularly with an electronic device of the consumer.

### BACKGROUND

In transactions between consumers and merchants such as restaurants, cinemas, or merchandise retail stores, etc., the transactions may be paid by cash or cashless modes such as credit cards. In order to accept cashless payment modes, merchants need to install billing machines or point-of-sale (POS) terminals, as well as related network infrastructure. For smaller merchants such as family-owned retail stores, installation of such equipment can be costly and their profit margin may not warrant such additional spending. As such, these smaller merchants have reduced revenue as they lose out on consumers who do not have sufficient cash at the time of the transactions and also consumers who choose to pay for transactions with cashless modes.

United States Publications 2017/0004488 and 2016/0275482 describe payment systems which can be adopted by merchants to facilitate payments of transactions. However, these payment systems require the merchants to use an electronic device, which could be a merchant billing machine or a mobile phone, thereby requiring the merchants to spend additional and possibly unwarranted costs on such equipment.

In addition, in markets where cash is the dominant payment mode, consumers who prefer to pay by cashless means such as credit cards are unable to know whether a merchant store accepts them before entering the store. If it turns out that the merchant store does not accept credit cards, the consumers have to pay by cash even though they did not intend to transact in cash. The consumers are thus forced to carry sufficient cash with them to prepare for such situations.

Therefore, in order to address or alleviate at least one of the aforementioned problems and/or disadvantages, there is a need to provide an electronic system and method for facilitating payment of a transaction in which there is at least one improved feature.

### SUMMARY

According to a first aspect of the present disclosure, there is an electronic system, a computerized method, and a non-transitory computer-readable storage medium for facilitating payment of a transaction with a consumer. The system comprises a server configured for performing steps of the method, comprising: receiving a transaction initiation request from an electronic device of the consumer; communicating, to the consumer electronic device, identification details of a number of merchants retrieved from a merchant database; receiving, from the consumer electronic device, a selection of a merchant from the number of merchants, the transaction performed with the selected merchant; receiving, from the consumer electronic device, details of a payment instrument of the consumer and cost data of the transaction; retrieving, from the merchant database, details of a financial account of the selected merchant; and communicating the consumer payment instrument details, transaction cost data, and merchant financial account details to a payment network for processing payment of the transaction.

According to a second aspect of the present disclosure, there is an electronic system, a computerized method, and a non-transitory computer-readable storage medium for facilitating payment of a transaction with a consumer. The system comprises an electronic device of the consumer configured for performing steps of the method, comprising: communicating a transaction initiation request from the electronic device to a server; receiving, from the server, identification details of a number of merchants; communicating, to the server, a selection of one merchant from the number of merchants, the transaction performed with the selected merchant; and communicating, to the server, details of a payment instrument of the consumer and cost data of the transaction, wherein the consumer payment instrument details and transaction cost data are communicable from the server to a payment network for processing payment of the transaction.

According to a third aspect of the present disclosure, there is an electronic system, a computerized method, and a non-transitory computer-readable storage medium for facilitating payment of a transaction with a consumer. The system comprises a server configured for performing steps of the method, comprising: receiving a transaction initiation request from an electronic device of the consumer; communicating, to the consumer electronic device, identification details and details of acceptable payment instruments of a number of merchants retrieved from a merchant database; receiving, from the consumer electronic device, a selection of a merchant from the number of merchants, the transaction performed with the selected merchant; receiving, from the consumer electronic device, details of a payment instrument of the consumer and cost data of the transaction, the consumer payment instrument being one of the acceptable payment instruments of the selected merchant; retrieving, from the merchant database, details of a financial account of the selected merchant; and communicating the consumer payment instrument details, transaction cost data, and merchant financial account details to a payment network for processing payment of the transaction.

An electronic system and method for facilitating payment of a transaction according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for facilitating payment of a transaction, in accordance with embodiments of the present disclosure.

FIG. 2 is a flowchart illustration of a computerized method for facilitating payment of a transaction, in accordance with embodiments of the present disclosure.

FIG. 3A to FIG. 3F are screenshot illustrations of the computerized method of FIG. 2 performed on a consumer electronic device, in accordance with embodiments of the present disclosure.

FIG. 4 is another flowchart illustration of a computerized method for facilitating payment of a transaction, in accordance with embodiments of the present disclosure.

FIG. 5 is a block diagram illustration of the technical architecture of a server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to an electronic system and method for facilitating payment of a transaction, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### System Overview

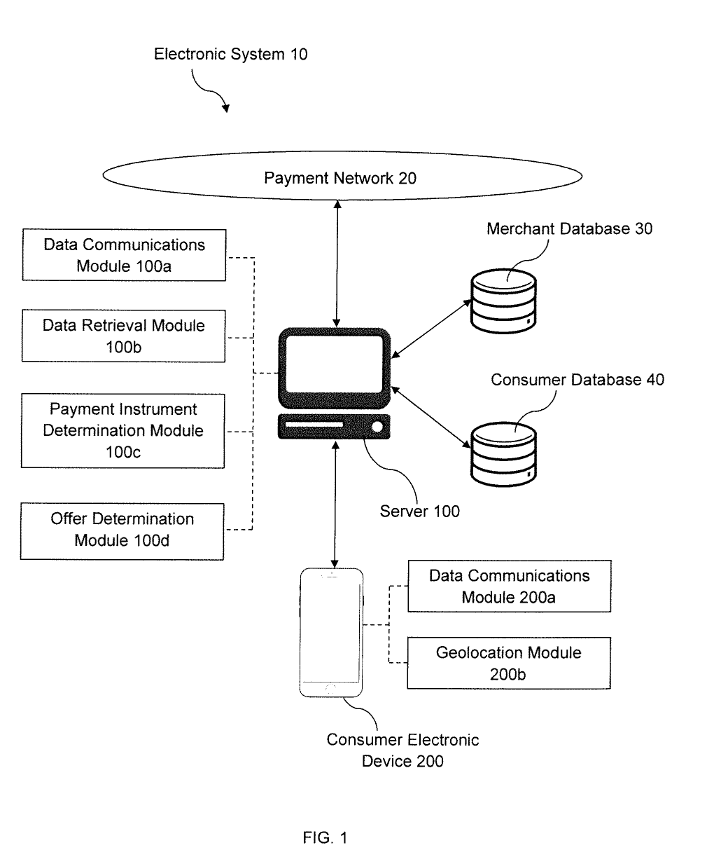

In representative or exemplary embodiments of the present disclosure, there is provided an electronic system 10 as illustrated in FIG. 1. The system 10 includes a server 100 having a processor and a data storage device or memory configured to store computer-readable instructions. The server 100 operative for facilitating payment of a transaction performed between a consumer and a merchant. The system 10 further includes an electronic device 200 of the consumer, wherein the consumer electronic device 200 is used to initiate payment of the transaction by the consumer. The system 10 further includes a payment network 20 for processing payment of the transaction. The system 10 further includes a merchant database 30 for storing details of merchants, such as identification details and details of financial accounts of the merchants.

The consumer initiates payment of the transaction with the consumer electronic device 200. The consumer logs in onto an application executed on the consumer electronic device 200 and communicates a transaction initiation request to the server 100. The server 100 and consumer electronic device 200 are communicable via data communication modules/components 100a and 200a thereof respectively. The consumer electronic device 200 receives, from the server 100, identification details of a number of merchants, i.e. at least one merchant. The identification details of the merchants are retrieved by a data retrieval module/component 100b the server 100 from the merchant database 30. These merchants may be represented on a geographical map that is displayed on the consumer electronic device 200, such as based on location of the consumer determined by a geolocation module/component 200b of the consumer electronic device 200. Various options and/or filters may be implemented to assist the consumer in reducing the number of merchants displayed and/or searching for merchants, such as by merchant name, distance from consumer, or merchant category code. Based on the identification details of the merchants are selectively accessible for viewing by the consumer, one merchant is selected from the number of merchants, wherein the transaction is performed with the selected merchant. The merchant identification details may include the name of the merchant store that is recognizable by the consumer. For example, for merchants within a shopping mall, the merchant identification details include the merchant names according to the shopping mall directory. After selecting the merchant, the consumer inputs, via a payment interface, details of a payment instrument of the consumer, e.g. payment card, and cost data of the transaction. The payment interface may be customizable and/or updatable to show the payment instruments that are acceptable by the selected merchant. Due to variable processing fees for different payment instruments, merchants may opt to accept certain payment instruments.

The consumer payment instrument details may be manually entered or retrieved, e.g. by a payment instrument determination module/component 100c, from a consumer database 40 which has details of payment instruments of consumers stored therein. There may be some offers, e.g. rebates and loyalty points, associated with some of the consumer payment instruments, and such offers may be determined by an offer determination module/component 100d of the server 100. The consumer payment instrument details and transaction cost data are communicated to the server 100. The server 100 also retrieves, from the merchant database 30, details of a financial account of the selected merchant. The server 100 then communicates the consumer payment instrument details, transaction cost data, and merchant financial account details to the payment network 20 for processing payment of the transaction.

An advantage of the present disclosure is that when the consumer is making a purchase transaction at the retail premises of a merchant, the consumer can initiate payment of the transaction with the consumer electronic device 200. The consumer selects, from the number of merchants and based on their identification details, this particular merchant which the consumer is performing the transaction with. The consumer payment instrument details and transaction cost data are provided by the consumer so that the selected merchant is not actively involved of the payment process. This obviates the need for the selected merchant to have any device, e.g. merchant billing machine, POS terminal, or mobile device, at the retail premises, while still enabling the selected merchant to receive the payment from the consumer.

### Method Steps

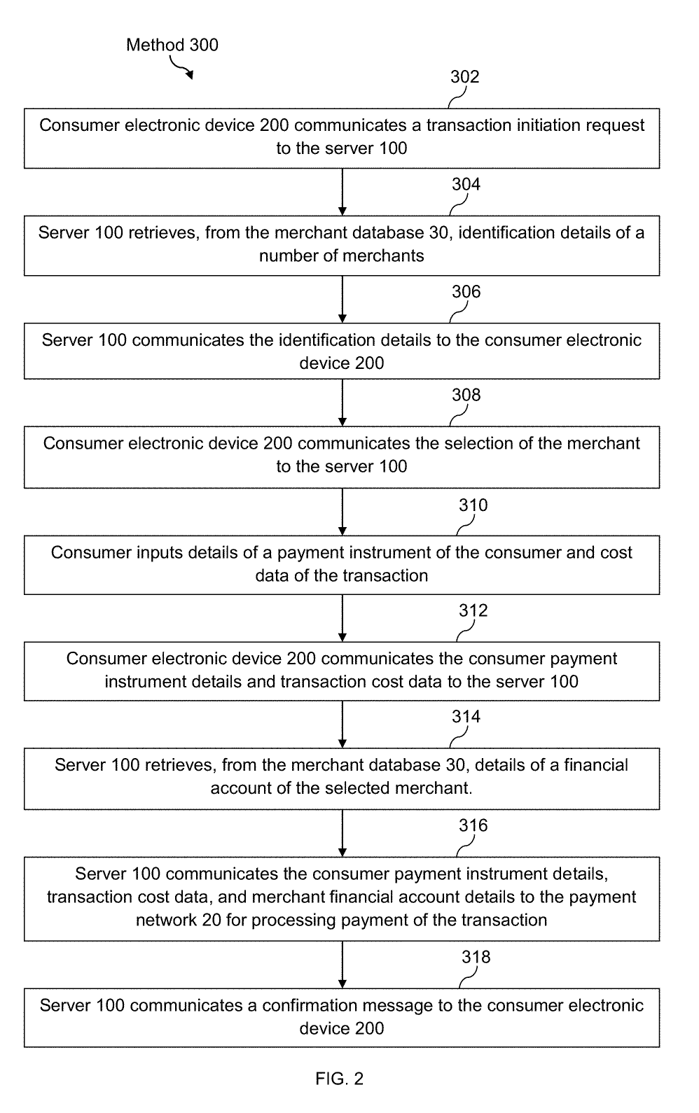

In various embodiments further with reference to FIG. 2, there is shown a computer-implemented or computerized method 300, i.e. implemented on the system 10, for facilitating payment of a transaction. The transaction may be performed when a consumer visits or patronizes the retail premises of a merchant. Alternatively, the transaction may be performed partially online, such as for selection of products for purchase, and the payment of the transaction is subsequently performed by the method 300. More specifically, the consumer initiates the payment of the transaction with the consumer electronic device 200.

The consumer electronic device 200 may be may be a mobile device such as a mobile phone, smartphone, personal digital assistant (PDA), tablets, laptop, or computer. Furthermore, the consumer electronic device 200 may be configured and operative as a digital wallet linked to one or more payment instruments of the consumer. The digital wallet may be operated on a software application executable on the consumer electronic device 200. An example of a digital wallet is MasterPass® by MasterCard®. Details of the payment instruments may be tokenized and stored locally on the consumer electronic device 200, or retrieved remotely with the consumer electronic device 200. The term “payment instrument” may refer to any suitable cashless payment mode or mechanism, such as payment cards. Payment cards may include credit cards, debit cards, prepaid cards, and/or charge cards which the customer uses to pay for transactions. In addition to payment cards, payment instruments may include, but are not limited to, membership cards, promotional cards, frequent flyer cards, identification cards, gift cards, and/or any other payment cards that may hold payment card information and which may be stored electronically.

The consumer firstly executes an application on the consumer electronic device 200, e.g. software/mobile application or online website/interface, to initiate payment of the transaction. The consumer inputs login details, including username and password (or other authentication parameter such as PIN or biometric data), into the application. In a step 302 of the method 300, the consumer electronic device 200 communicates a transaction initiation request to the server 100, the transaction initiation request including the login details for validation by the server 100. It will be appreciated that the consumer electronic device 200 includes a data communications module/component 200a and the server 100 similarly includes a data communications module/component 100a, wherein communications between the consumer electronic device 200 and server 100 occur between the data communications modules 100a and 200a.

Upon validation of the login details, the consumer is able to search for and locate the merchant for payment of the transaction. Particularly, in a step 304, the server 100 retrieves, with a data retrieval module/component 100b thereof and from the merchant database 30, identification details of a number of merchants. The identification details may include merchant identifiers, names, addresses, phone numbers, and/or merchant category codes, etc. In a step 306, the server 100 communicates the identification details to the consumer electronic device 200 for selectively viewing by the consumer.

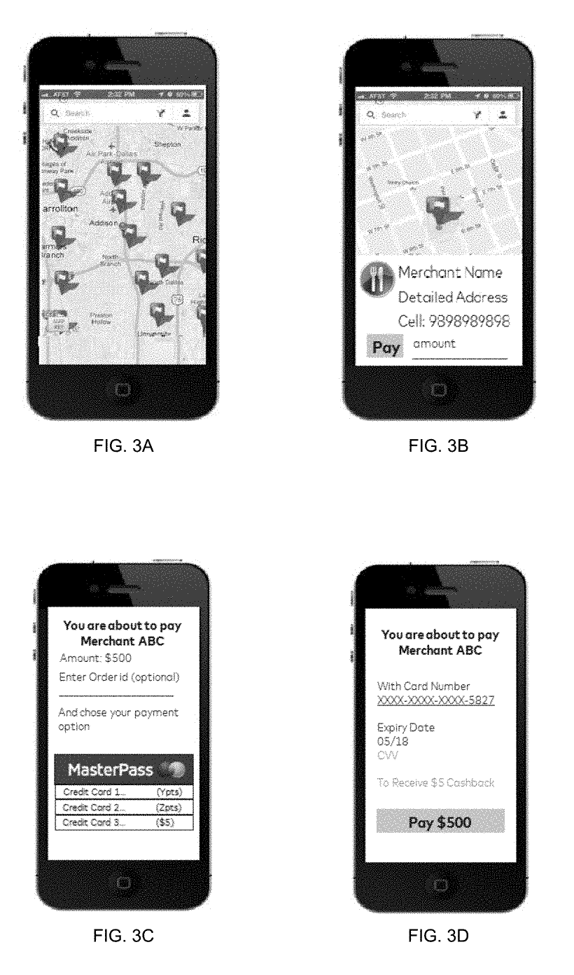

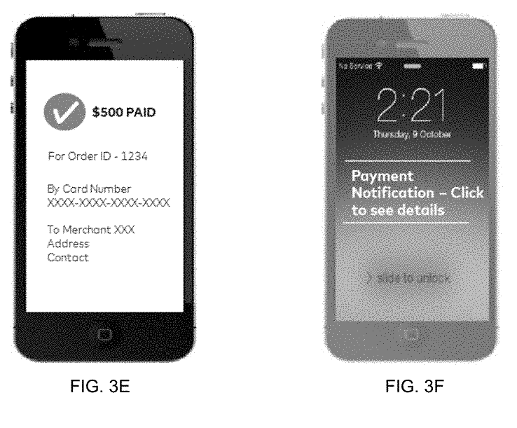

In one embodiment, the merchants are represented on a geographical map displayed on the consumer electronic device 200. FIG. 3A illustrates a screenshot of the geographical map whereon the merchants are represented. The identification details are retrieved by the server 100 and communicated to the consumer electronic device 200 for selectively viewing by the consumer. From the map and based on the geographical location of the consumer electronic device 200 and location details of the merchants, the consumer is able to locate the merchant for payment of the transaction. Various options and/or filters may be implemented to assist the consumer in searching for the merchant. For example, a staff at the merchant retail premises may provide the consumer with the some basic identification details of the merchant, e.g. name, address, phone number, merchant category code, etc., so that the consumer can more easily search for the merchant. After locating the merchant on the geographical map, the consumer may select to view the identification details to verify that the merchant is the correct one, as illustrated in a screenshot in FIG. 3B. The consumer then makes the selection of the merchant from among the number of merchants represented on the geographical map.

In another embodiment, instead of the merchant staff providing some basic identification details to the consumer, there may be a matrix barcode, e.g. QR code, on display at the merchant retail premises. The consumer uses the consumer electronic device 200 to scan the matrix barcode and read optical data therefrom. Some basic identification details of the merchant are embedded within the optical data and are readable by the consumer electronic device 200. With these basic identification details, the consumer electronic device 200 automatically searches for the merchant on the geographical map. After locating the merchant on the geographical map, the consumer may select to view the identification details to verify that the merchant is the correct one, before making the selection of the merchant from among the number of merchants represented on the geographical map. In some other embodiments, the basic identification details may be embedded in other data formats that are communicable to the consumer electronic device 200 via known contactless/wireless communication protocols, such as Wi-Fi, near field communication (NFC), or Bluetooth.

In a step 308, the consumer electronic device 200 communicates the selection of the merchant to the server 100, wherein the transaction performed with the selected merchant. As illustrated in screenshots in FIG. 3C and FIG. 3D, the consumer inputs, in a step 310 and via a payment interface or checkout page as shown in FIG. 3C, details of a payment instrument of the consumer and cost data of the transaction, i.e. the amount to pay the selected merchant. The consumer payment instrument details may be manually entered into the consumer electronic device 200, or the consumer payment instrument may be selected from the consumer database 40 which stores details of a plurality of payment instruments of the consumer. Optionally, the consumer may input identification data of the transaction, e.g. an order number. It will be appreciated that the merchant database 30 and consumer database 40 may reside locally on the server 100, or alternatively on a remote server or computer communicatively linked to the server 100.

In a step 312, the consumer electronic device 200 communicates the consumer payment instrument details and transaction cost data, and optionally the transaction identification data, to the server 100. The consumer payment instrument details manually input by the consumer may be stored on the consumer database 40. In a step 314, the server 100, with the data retrieval module 100b thereof and from the merchant database 30, retrieves details of a financial account of the selected merchant based on the identification details of the selected merchant (from the step 304). In a step 316, the server 100 communicates the consumer payment instrument details, transaction cost data, and merchant financial account details to the payment network 20 for processing payment of the transaction. It will be appreciated that the processing of payment of the transaction by the payment network 20, including communications between the acquirer financial institution/bank of the merchant financial account and issuer financial institution/bank of the consumer payment instrument, is performed in a standard manner and will be readily understood by the skilled person.

Upon completion of the payment of the transaction, in a step 318, the server 100 communicates a confirmation message to the consumer electronic device 200, informing the consumer that the payment has been successfully completed. FIG. 3E illustrates a screenshot of the confirmation message to the consumer. Optionally, if the selected merchant is using a mobile device/phone, the server 100 may communicate a confirmation message to the merchant mobile device/phone, informing the selected merchant that the payment has been successfully completed, and the merchant may proceed to deliver the purchased products to the consumer. FIG. 3F illustrates a screenshot of the confirmation message to the merchant. The details in either or both confirmation messages may include the transaction cost data or transaction amount, consumer identification details such as phone number associated with the consumer electronic device 200, last 4 digits of the consumer payment instrument (e.g. credit card), and/or transaction order number. After completion of the transaction, the consumer may save details of the selected merchant on the consumer electronic device 200, so that it would be more convenient to retrieve details of the merchants for future transactions. More broadly, the details of one or more merchants may be stored on the consumer electronic device 200, particularly when the consumer has identified certain merchants on the geographical map that he/she would potentially transact with in future.

As described above, an advantage is that when the consumer is making a purchase transaction at the retail premises of a merchant, the consumer can initiate payment of the transaction with the consumer electronic device 200. The need for the merchant to have any device, e.g. merchant billing machine, POS terminal, or mobile device, installed at the retail premises is obviated. In one scenario, the consumer may be at a merchant retail store and makes a purchase of some products. The consumer has to make a payment to the merchant for this purchase transaction. The merchant calculates the total price of the products and informs the consumer of the amount to be paid. The consumer locates and selects the merchant using the consumer electronic device 200, e.g. with a geographical map displayed thereon, and inputs the transaction amount. These details are communicated to the server 100, along with consumer payment instrument details, and processing of payment of the transaction takes place at the payment network 20 in a standard manner known to the skilled person. The method 300 is beneficial to consumers and merchants particularly in the developing nations and semi-urban regions where merchants do not want any hassle and/or do not want to spend unnecessary money on installation of merchant billing machines/POS terminals. The method 300 advantageously allows consumers to initiate payment of transactions without any devices installed at the merchant retail premises.

### Payment Interface Customization

In some embodiments, the payment interface shown in FIG. 3C may be customized according to various payment options. Particularly, different merchants enrol with their financial institutions to accept various payment instruments which may not be the same among merchants. Due to variable processing fees for different payment instruments, merchants may opt to accept certain payment instruments. For example, a first merchant may accept credit cards only but not a digital wallet; a second merchant may accept digital wallets only; a third merchant may accept credit cards and electronic funds transfer only. Furthermore, the payment instruments used by the consumer and the payment instruments accepted by merchants may not match each other. Both consumer and merchants may respectively prefer certain payment instruments, such as credit cards associated with MasterCard® or Visa®. If the consumer intends to use a particular payment instrument which is not within the payment options accepted by a merchant, the consumer will not be able to transact with the merchant with this particular payment instrument.

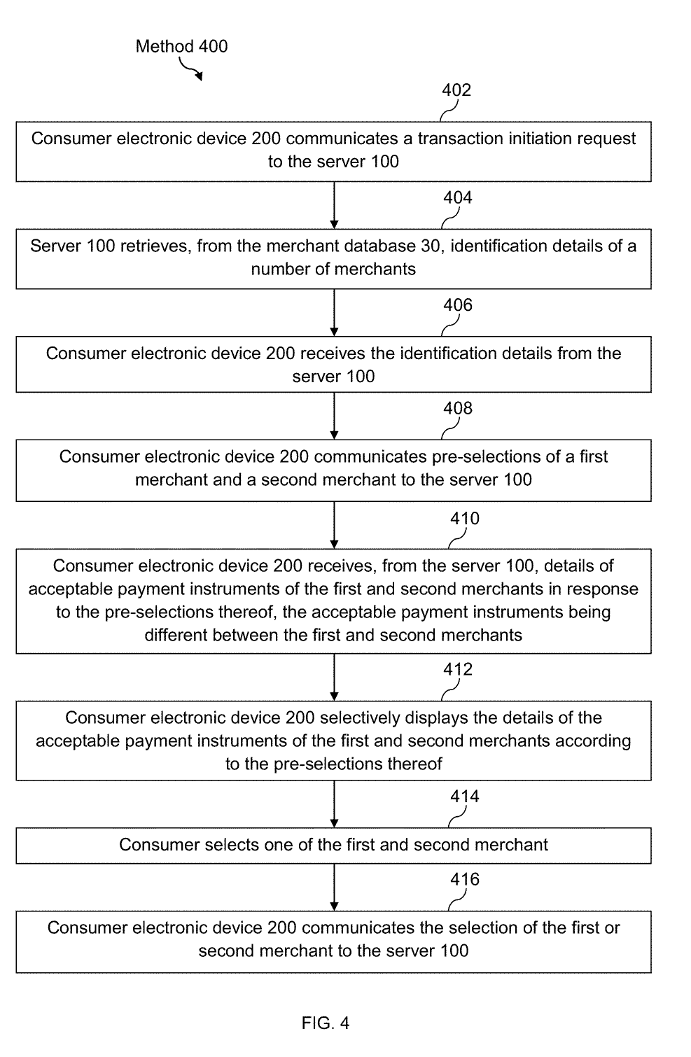

With reference to FIG. 4, there is shown a computer-implemented or computerized method 400 for facilitating payment of a transaction, similar to the method 300 in that there are some common steps therebetween. For purpose of brevity, it will be appreciated that various aspects of the method 300 apply analogously to the method 400. In a step 402, the consumer electronic device 200 communicates a transaction initiation request to the server 100, the transaction initiation request including the login details for validation by the server 100. In a step 404, the server 100 retrieves, with the data retrieval module 100b thereof and from the merchant database 30, identification details and details of acceptable payment instruments of a number of merchants.

In a step 406, the consumer electronic device 200 receives the identification details of the number of merchants from the server 100, wherein the merchants are represented on a geographical map displayed on the consumer electronic device 200. The consumer may browse through the merchants using the geographical map, and may selectively call out a merchant by pre-selecting it. For example, while the consumer is searching for a merchant on the geographical map, the consumer pre-selects the merchant. The details of the acceptable payment instruments of the pre-selected merchant are communicated from the server 100 to the consumer electronic device 200. Based on these details, the consumer is able to see whether he/she has a payment instrument that is acceptable by the pre-selected merchant. Knowing which payment instruments are acceptable by a merchant prevents occurrence of situations wherein the consumer is unable to complete the transaction because he/she does not have a payment instrument acceptable by the merchant. For example, a merchant may opt to accept payment cards by MasterCard® only, such that consumers with Visa® cards will not be able to transact with the merchant. The consumer may also choose to transact with merchants that accept certain payment instruments, such as if the consumer wishes to earn rebates or points on the consumer payment instrument.

If the consumer intends to purchase an item from a merchant, and there are two or more merchants located in close proximity to one another, the consumer may wish to see the acceptable payment instruments of these merchants before deciding which merchant to transact with. The consumer may call out or pre-select these merchants on the geographical map to see details of their acceptable payment instruments. Accordingly, in a step 408, the consumer electronic device 200 communicates, to the server 100, pre-selections of a first merchant and a second merchant. In a step 410, the consumer electronic device 200 receives, from the server 100, details of acceptable payment instruments of the first and second merchants in response to the pre-selections thereof, the acceptable payment instruments being different between the first and second merchants. In a step 412, the consumer electronic device 200 selectively displays the details of the acceptable payment instruments of the first and second merchants according to the pre-selections thereof. The first and second merchants thus have different acceptable payment instruments, such that for example, only one of the first and second merchants accepts the payment instrument which the consumer intends to use.

In a step 414, the consumer selects one of the first and second merchants. In a step 416, the consumer electronic device 200 communicates the selection of the first or second merchant to the server 100, wherein the transaction is performed with the selected merchant and using a payment instrument of the consumer, the consumer payment instrument being included within the acceptable payment instruments of the selected merchant.

In a payment interface as shown in FIG. 3C, the consumer views the payment instruments that are acceptable by the selected merchant. For example, among the various payment instruments or payment options in the market, those that are acceptable by the selected merchant are highlighted to the consumer, whereas those that are unacceptable are faded or hidden from view. The consumer is thus able to see whether he/she has a payment instrument that is acceptable by the selected merchant. In one example, the selected merchant accepts only MasterCard® and Visa® cards. The consumer electronic device 200 would only display the MasterCard® and Visa® payment options; the other possible payment options, such as American Express® are hidden from view in the payment interface, thereby informing the consumer that only MasterCard® and Visa® cards are acceptable by the selected merchant. Alternatively, instead of hiding the unacceptable payment options from view, they may be faded out in the payment interface,

To perform the transaction with the selected merchant, the consumer inputs, via the payment interface, details of a payment instrument of the consumer and cost data of the transaction. Notably, the consumer payment instrument is one of the acceptable payment instruments of the selected merchant. In one embodiment, the consumer payment instrument details and transaction cost data are manually entered into the consumer electronic device 200.

In another embodiment, the consumer first inputs the transaction cost data. Based on the transaction cost data, the payment interface may be updated to refresh the payment instruments acceptable by the selected merchant. Due to variable processing fees by different payment instruments, the selected merchant, as well as other merchants, may opt to accept certain payment instruments depending on the transaction amount. The payment instrument determination module 100c may determine, from the merchant database 30, the payment instruments acceptable by the selected merchant based on the transaction cost data. For example, some payment instruments may only be made available to consumers if the transaction cost data is above a predefined threshold amount, so as to justify the processing fees. The payment interface is thus updatable with the acceptable payment instruments of the selected merchant based on the transaction cost data. The consumer then inputs the consumer payment instrument details.

The consumer electronic device 200 may be configured to determine whether the consumer payment instrument is included within the acceptable payment instruments of the selected merchant. If yes, the consumer electronic device 200 communicates the consumer payment instrument details to the server 100 for processing payment of the transaction. However, if the consumer payment instrument is excluded from the acceptable payment instruments of the selected merchant, the consumer electronic device 200 prevents communication of the consumer payment instrument details to the server 100. Accordingly, the consumer electronic device 200 is configured to detect the type of payment instrument input by the consumer and to reject consumer payment instruments that are not acceptable by the selected merchant. The type of consumer payment instrument, e.g. credit card, may be detected by the first digit of the credit card number. Notably, “3” refers to American Express® cards, “4” refers to Visa® cards, and “5” refers to MasterCard® cards.

In another embodiment, if the consumer has details of a plurality of consumer payment instruments stored on the consumer database 40, the data retrieval module 100b of the server 100 is able to retrieve these details from the consumer database 40. A payment instrument determination module 100c of the server 100 is configured to determine the common payment instruments among the payment instruments acceptable by the selected merchant and the consumer payment instruments. It will be appreciated that the common payment instruments may be determined based additionally on the transaction cost data. Details of the common payment instruments are subsequently communicated to the consumer electronic device 200, such that for each of the first and second merchants, the acceptable payment instruments selectively displayed on the consumer electronic device 200 consist of common payment instruments between the consumer and the merchant. The consumer is then able to select which of the common payment instruments to use for payment of the transaction. Alternatively, the server 100 may communicate details of the consumer payment instruments and the acceptable payment instruments of the merchants to the consumer electronic device 200. The consumer electronic device 200 then analyzes the consumer payment instruments and acceptable merchant payment instruments to determine which are the common payment instruments between the consumer and the merchants.

### Search Options

As mentioned above, the consumer may search and locate for a merchant using the geographical map whereon multiple merchants are represented. More specifically, the merchants are shown in the geographical map according to the location details of their retail premises. The consumer may filter the merchants according to various parameters, including but not limited to, merchant category code (e.g. restaurants, grocery stores, etc.), postal codes, area/region, distance from consumer determined with a geolocation module/component 200b in the consumer electronic device 200, recent merchants which transactions were performed with, and merchants whose details are saved in the consumer electronic device 200.

Additionally, the consumer may filter the merchants according to a preferred payment option. The consumer may indicate a particular payment instrument as his/her preferred payment option. The merchants represented on the geographical map may be filtered such that only merchant that accept this particular payment instrument are shown. With this filtering option, consumers can know which merchants are able to accept certain payment instruments or credit cards of the consumers' choice without being present at the retail premises. This upfront information is useful to consumers, as they need not carry too much cash with them if they are aware of the merchants that accept cashless payment instruments. This reduces their losses in the unfortunate event of pickpocketing/theft/robbery.

### Offers

In some embodiments, there are offers associated with payment instruments of the consumer. For example, spending on a credit card issued by a particular issuer financial institution/bank offers the consumer incentives such as cash rebates, reward points, frequent flyer miles, and discounts. As different issuer financial institutions provide various offers for various payment instruments, details of such offers are requested from the issuer financial institutions. The server 100 may communicate via the payment network 20 to the issuer financial institutions of the consumer payment instruments, a request for offer details associated with the consumer payment instruments. In one embodiment, the consumer has selected the payment instrument to use for payment of the transaction, and this request for offer details is specific to the selected payment instrument and is performed at the time of the transaction.

In another embodiment, the consumer is unsure of which payment instrument, such as from among those stored on the consumer database 40, to use. The request for offer details is communicated to the respective issuer financial institutions of the consumer payment instruments. An offer determination module/component 100d in the server 100 then aggregates the offer details provided by the issuer financial institutions. The request for offer details may be performed at the time of the transaction, or in periodic batch updates wherein the offer details are aggregated and stored on the consumer database 40 for subsequent retrieval. The server 100 then communicates the offer details to the consumer electronic device 200 for viewing by the consumer, thereby giving the consumer a choice of deciding which offer for which payment instrument is the most beneficial.

The offer details of the consumer payment instruments may be presented in various formats, depending on the nature of the offers. The incentives/benefits offered by the issuer financial institutions for use of their payment instruments may be in the form of a loyalty/reward points or cash rebates for various threshold spending amounts. The incentives/benefits may also be associated with the merchant category codes. Other variations to the offers/incentives/benefits are possible as will be readily known to the skilled person.

Additionally, the offer determination module 100d calculates the exact points and/or cash rebate amounts for each consumer payment instrument and based on the transaction cost data. This allows the consumer to know clearly the potential incentives/benefits from using a certain payment instrument, and to make an informed decision on which payment instrument to use for payment of the transaction.

In some embodiments, merchants may provide offers such as temporary promotions or flash sales. These offers may be specific to certain stores of the merchants. For example, a merchant store may offer a 5% cash rebate or discount for transactions paid with payment instruments issued by a predefined issuer financial institution. In this case, the server 100 updates the transaction cost data based on offers by the merchant, such that the consumer pays a lower discounted amount for the transaction. Each offer from a merchant is associated with one or more of the following variables—amount of discount/points/cash rebate, threshold spending amount, issuer financial institution, type of payment instrument, and duration of the offer.

Similarly, the request for offer details is communicated to the respective issuer financial institutions of the consumer payment instruments. The offer determination module 100d then aggregates the offer details provided by the issuer financial institutions. The request for offer details may be performed at the time of the transaction, or in periodic batch updates wherein the offer details are aggregated and stored on the merchant database 30 for subsequent retrieval. The server 100 then communicates the offer details to the consumer electronic device 200 for viewing by the consumer, thereby giving the consumer a choice of deciding which offer by the merchant and for which payment instrument is the most beneficial.

### Enrolment

There is an enrolment procedure for consumers and merchants so that they will be able to use the system 10 and method 300 for facilitating payment of transactions. For consumers, the enrolment procedure is performed on the consumer electronic device 200. Login details including username and password are generated for each consumer. The login details are input by the consumer for each use of the application to initiate payment of a transaction. During enrolment, the consumer may input details of a number of payment instruments for communication to the server 100 and storage on the consumer database 40. These details may also be tokenized and stored locally on the consumer electronic device 200. In addition, the consumer may indicate a preferred payment instrument that will be the default payment instrument for payment of transactions. As there may be multiple consumer payment instruments that have varying offers from their issuer financial institutions, the consumer may indicate which type of offer he/she prefers, such as frequent flyer miles or cash rebates. The payment instruments may be prioritized according to the preferred offers.

For merchants, the enrolment procedure is performed through one or more acquirer financial institutions/banks. A unique merchant identifier is generated for each merchant, and there may be different identifiers for different physical stores of the merchant. The merchant identifiers, along with other merchant details such as merchant name, physical addresses of stores, phone numbers, and acquiring financial institution details, are stored on the merchant database 30. During enrolment, the merchant may indicate which payment instruments to accept for receiving payment of transactions. The acceptable payment instruments of the merchant may also be updated after enrolment in a similar manner. The merchant may setup rules to accept different payment instruments for different transaction amounts. If the merchant uses multiple acquirer financial institutions, the merchant can utilize dynamic or intelligent payment routing to decide which acquirer financial institution to use for a transaction so as to optimize the merchant discount rate for the merchant. The choice of acquirer financial institution may depend on various factors such as the transaction amount. The merchant may periodically setup new offers to incentivize consumers to transact with the merchant. Details of the offers are setup through the acquirer financial institutions and stored on the merchant database 30. As some of the offers may relate to the issuer financial institutions of the consumer payment instruments, the server 100 may communicate an initial request to the respective issuer financial institutions for verification of the offers.

### Technical Architecture

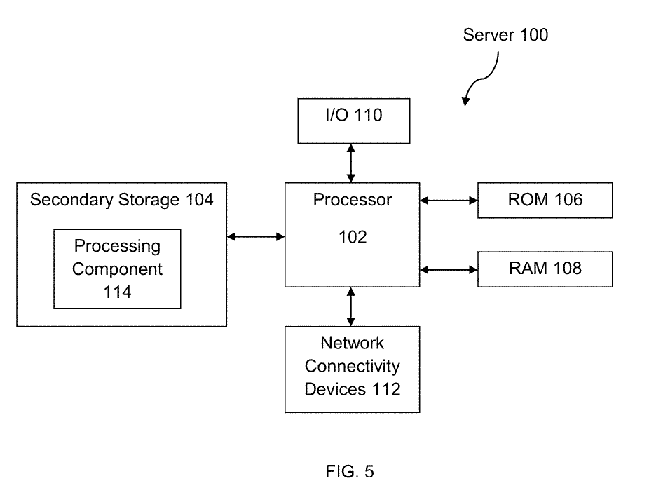

The following is a description of the technical architecture of the server 100 with reference to FIG. 5. It will be appreciated that the consumer electronic device 200 may have a similar technical architecture as well.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for facilitating payment of a transaction are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for facilitating payment of a transaction with a consumer, the system comprising a server configured for performing steps comprising:
receiving a transaction initiation request from an electronic device of the consumer;
communicating, to the consumer electronic device, identification details of a number of merchants retrieved from a merchant database;
receiving, from the consumer electronic device, a selection of a merchant from the number of merchants, the transaction performed with the selected merchant;
receiving, from the consumer electronic device, details of a payment instrument of the consumer and cost data of the transaction;
retrieving, from the merchant database, details of a financial account of the selected merchant; and
communicating the consumer payment instrument details, transaction cost data, and merchant financial account details to a payment network for processing payment of the transaction.

2. The system according to claim 1, the steps further comprising retrieving from the merchant database and communicating to the consumer electronic device, details of payment instruments acceptable by the merchants.

3. The system according to claim 2, wherein the consumer payment instrument is selected from a plurality of consumer payment instruments stored on a consumer database.

4. The system according to claim 3, the steps further comprising communicating, to the consumer electronic device, details of common payment instruments among the payment instruments acceptable by the merchants and the consumer payment instruments.

5. The system according to claim 2, the steps further comprising determining the payment instruments acceptable by the merchants based on the transaction cost data.

6. The system according to claim 1, the steps further comprising updating the transaction cost data based on offers by the selected merchant.

7. The system according to claim 3, the steps further comprising communicating via the payment network to issuer financial institutions of the consumer payment instruments, a request for offer details associated with the consumer payment instruments.

8. The system according to claim 7, the steps further comprising communicating the offer details to the consumer electronic device.

9. An electronic system for facilitating payment of a transaction with a consumer, the system comprising an electronic device of the consumer configured for performing steps comprising:
communicating a transaction initiation request from the electronic device to a server;
receiving, from the server, identification details of a number of merchants;
communicating, to the server, a selection of one merchant from the number of merchants, the transaction performed with the selected merchant; and
communicating, to the server, details of a payment instrument of the consumer and cost data of the transaction,
wherein the consumer payment instrument details and transaction cost data are communicable from the server to a payment network for processing payment of the transaction.

10. The system according to claim 9, the steps further comprising reading optical data for selecting the one merchant from the number of merchants.

11. The system according to claim 9, wherein the number of merchants is represented on a geographical map displayed on the consumer electronic device.

12. The system according to claim 9, the steps further comprising communicating identification data of the transaction to the server.

13. The system according to claim 9, the steps further comprising communicating, to the server, details of a plurality of consumer payment instruments for storing on a consumer database.

14. The system according to claim 13, the steps further comprising receiving, from the server, details of payment instruments acceptable by the merchants.

15. The system according to claim 14, the steps further comprising receiving, from the server, details of common payment instruments among the payment instruments acceptable by the merchants and the consumer payment instruments.

16. A computerized method for facilitating payment of a transaction with a consumer, the method performed by a server of an electronic system according to claim 1.

17. A computerized method for facilitating payment of a transaction, the method performed by an electronic device of a consumer, the method comprising:
communicating a transaction initiation request from the electronic device to a server;
receiving, from the server, identification details of a number of merchants represented on a geographical map displayed on the electronic device;
communicating, to the server, pre-selections of a first merchant and a second merchant;
receiving, from the server, details of acceptable payment instruments of the first and second merchants in response to the pre-selections thereof, the acceptable payment instruments being different between the first and second merchants;
selectively displaying, on the electronic device, the details of the acceptable payment instruments of the first and second merchants according to the pre-selections thereof,
wherein the transaction is performed with one of the first and second merchants selected by the consumer and using a payment instrument of the consumer, the consumer payment instrument being included within the acceptable payment instruments of the selected merchant.

18. The method according to claim 17, further comprising:
determining whether the consumer payment instrument is included within the acceptable payment instruments of the selected merchant; and
if yes, communicating the consumer payment instrument details to the server for processing payment of the transaction.

19. The method according to claim 18, further comprising preventing communication of the consumer payment instrument details to the server if the consumer payment instrument is excluded from the acceptable payment instruments of the selected merchant.

20. The method according to claim 17, further comprising receiving details of payment instruments of the consumer stored on a consumer database, wherein for each of the first and second merchants, the acceptable payment instruments selectively displayed on the electronic device consist of common payment instruments between the consumer and the merchant.
